(19) United States
(12) Patent Application Publication
(10) Pub. No.: US 2004/0194784 A1
(43) Pub. Date: Oct. 7, 2004

(54) Respiratory particulate filter

(76) Inventor: Archie Bertrand, Madisonville, LA (US)

Correspondence Address: WADDEY & PATTERSON, Bank of America Plaza, 414 Union Street, Suite 2020, Nashville, TN, 37219, US

(21) Appl. No.: 10/405,896

(22) Filed: Apr. 1, 2003

(51) Int. Cl. A62B 7/10; A62B 18/02

(52) U.S. Cl. 128/206.18; 128/205.27; 128/205.29

(57) ABSTRACT

A particulate filter including a centrally disposed synthetic meshed filter region surrounded by an adhesive region. The adhesive region, preferably formed of porous fabric with a hypoallergenic adhesive coating on one side, includes a proximal tab, left and right medial tabs, and a distal tab which adhere to the base, lateral, and tip aspects of the nose. The filter includes pharmaceutical agents used to inhibit allergic reactions, aid in the removal of particulates in the air during inspiration, or to create desired physiological effects in the user of the filter. Several techniques are disclosed to accomplish this task, including coating or impregnating the filter material can be with a pharmaceutical compound, adding a pharmaceutical compound to the adhesive use to removably attach the filter to the nose of a user of the filter, or applied to the adhesive section or attachment region.

### FIELD OF THE INVENTION

The present invention relates generally to the respiratory filtration of dust, pollen and other airborne particulates, and more particularly to a disposable filter which removably attaches to the user's nose and filters particulates during inspiration of ambient air through the nostrils.

### BACKGROUND OF THE INVENTION

It will be appreciated by those skilled in the art that as more people become aware that they suffer from allergies, many are taking steps to prevent dust, pollen, and other allergens from entering the respiratory system. Some have tried wearable filters in a variety of shapes and forms. Some cover the mouth and nose, some cover the mouth, while others cover only the nostrils, the latter being very cumbersome and unsightly. It will further be appreciated by those skilled in the art that to be practical for everyday use, such filters must be easy to manufacture and inexpensive to use, and have some level of aesthetics in the design. To this end, there have been several attempts to provide a re-usable or disposable respiratory particulate filters for the nose.

U.S. Pat. No. 3,774,601 issued to Langone on Nov. 27, 1973, and U.S. Pat. No. 4,984,302 issued to Lincoln on Jan. 5, 1991, disclose the use of cotton, wool, carbon, polyethylene or polyester as a material used to filter particulate in a device attached at the nose. Unfortunately, in order to be secured, the Lincoln filter must attach high on sides of the nose which looks and feels awkward and uncomfortable. Similarly, the Langone filter covers both the mouth and the nose and is very cumbersome and unsightly.

U.S. Pat. No. 2,667,869 issued to D'Elia on Feb. 2, 1954, describes a device which wraps around the user's ears to cover the mouth. This is clearly intended not to filter particulates but to protect the user's mouth and ears. This, like Lincoln and Langone, is a very awkward device.

U.S. Pat. No. 3,802,429 issued to Bird on Apr. 9, 1974, shows a full surgical mask which must be tied to the back of user's head. This is awkward and not simple to use.

U.S. Pat. No. 4,004,584 issued to Geaney on Jan. 25, 1977, discloses a device which is placed over the user's face. Unfortunately, this too is awkward and covers too much of the face to have any aesthetic appeal.

U.S. Pat. No. 4,856,509 issued to Lemelson on Aug. 15, 1989, discloses a full mask which ties to the back of user's head. Unfortunately, this is too bulky to wear over a large period of time. The same can be said for U.S. Pat. No. 4,920,960 issued to V. Hubbard, et al issued May 1, 1990.

U.S. Pat. No. 4,354,489 issued to Riaboy on Oct. 19, 1982, discloses a filter which is placed over the mouth and a separate filter which is placed over the nose. The nose filter covers more of the nose than is necessary. The same is true with U.S. Pat. No. 4,240,420 issued to Riaboy on Dec. 23, 1980.

U.S. Pat. No. 3,463,149 issued Albu on Aug. 26, 1969, discloses an intrusive nose filter which fits within the nostrils of the user. This attachment was necessary because no one in the prior art has determined an optimum means to provide a very small filter which still attaches to the user's nose effectively.

What is needed, then, is a disposable filter which can be easily attached to the nose and effectively used to remove airborne allergens during respiration. This filter must be aesthetically pleasing and universally adhere to and accommodate virtually all nose shapes yet not cover more of the nose than is actually necessary. This device is presently lacking in the prior art.

### SUMMARY OF THE INVENTION

The present invention discloses a particulate filter including a centrally disposed synthetic meshed filter region surrounded by an adhesive region. The adhesive region, preferably formed of porous fabric with a hypoallergenic adhesive coating on one side, includes a proximal tab, left and right medial tabs, and a distal tab which adhere to the base, lateral, and tip aspects of the nose. This leaves the upper surfaces of the nose exposed while covering the nostrils with the filter material. In one embodiment, the proximal tab is arched along its inner margin with the filter region to better adapt it to fit at the junction point of the face with the bottom of the nose. Left and right intertabular strips, having curved inner and outer margins, join the sides of the proximal tab to the proximal ends of the medial tabs.

A paper backing covers the adhesive-coated, nose contacting surface or the filter, which is peeled off immediately prior to use.

The filter includes pharmaceutical agents used to inhibit allergic reactions, aid in the removal of organics in the air during inspiration, or to create desired physiological effects in the user of the filter. Several techniques are disclosed to accomplish this task, including coating or impregnating the filter material can be with a pharmaceutical compound, adding a pharmaceutical compound to the adhesive use to removably attach the filter to the nose of a user of the filter, or applied to the adhesive section or attachment region.

Accordingly, one object of the present invention is to provide a respiratory particulate filter which securely attaches to the distal, medial, and proximal aspects of the nose while covering only the very lower portions of the nose.

A still further object of the present invention is to provide a filter which is effective in removing airborne allergens but does not trap or absorb moisture.

Another object of the present invention is to provide a filter which is easy to use and aesthetically pleasing.

A still further object of the present invention is to provide a disposable filter which is easily applied and removed.

Yet a further object of the present invention is to provide a nasal respiratory filter that includes pharmaceutical agents adapted to induce physiological effects in the bloodstream.

In yet another object of the present invention is to provide a pharmaceutical agent mixed in with the adhesive of a nasal filter.

Other further objects, features, and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a side view of the filter of the present invention as conformed to and attached to a human user's face.

FIG. 2 is a plan view of the filter of the present invention with the adhesive backing removed.

FIG. 3a is a side cut-away view of one embodiment of the filter of the present invention.

FIG. 3b is an enlarged cutaway side view of a section of the filter material.

FIG. 4 is a plan view of the nose filter of the present invention with the adhesive backing partially removed.

FIG. 5 is a plan view of an alternate embodiment of the filter of the present invention.

FIG. 6 is one embodiment of this invention attached to the nose of an animal.

### DESCRIPTION OF THE PREFERRED EMBODIMENT

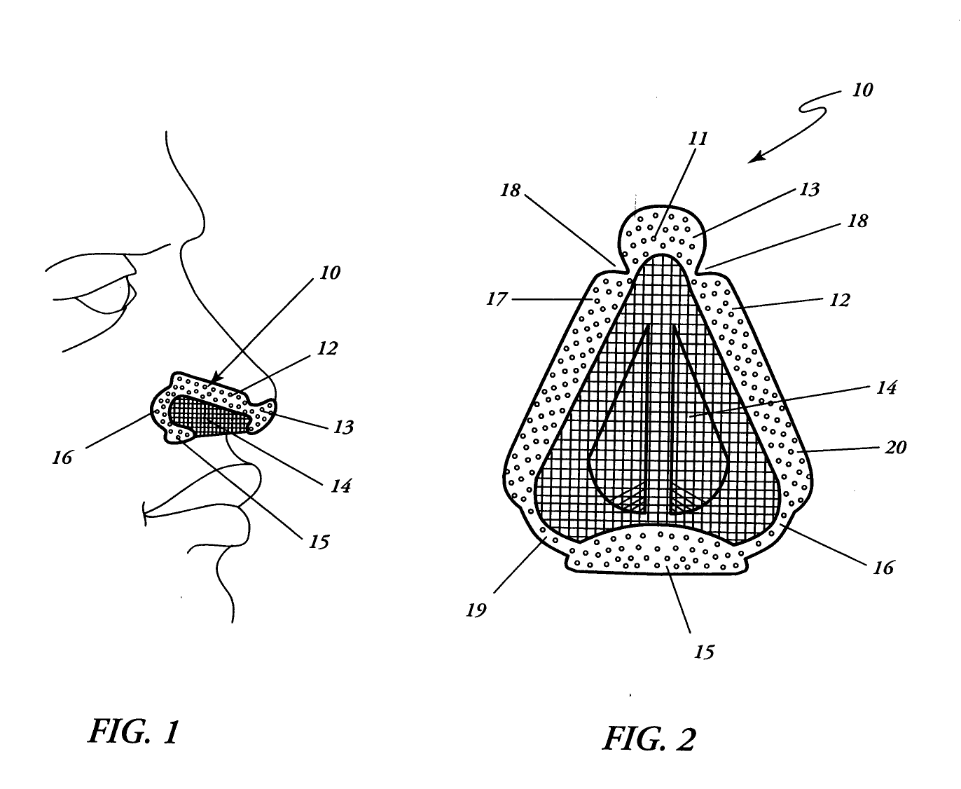

Referring now to FIGS. 1 and 2, there is shown generally at 10 the particulate filter of the present invention as it is placed on user's face and nose. As best seen on FIG. 2, in one embodiment the filter 10 has a generally triangular shape defined by an inner filter region 14 surrounded by an adhesive region 20. The novel shape and proportion of adhesive region 20 is important to the improved function and aesthetic appearance of the filter, including its ability to readily conform to noses of a variety of shapes and sizes. Accordingly, adhesive region 20 is made of a continuous piece of flexible synthetic material which includes a plurality of pores 11 which allow air to reach the skin and moisture to escape. The overall shape of adhesive region 20 is defined by a circular distal tab 13, which is joined by generally rectangular left and right medial tabs 17 and 12 to proximal tab 15. As seen on FIG. 1, distal tab 13 conforms and adheres to the lower surfaces of the tip of the nose while proximal tab 15 attaches to the skin found at the junction of the face with the bottom of the nose. Proximal tab 15 has a straight outer margin and an arched inner margin to further enhance the level of conformity.

Left and right intertabular strips 19 and 16 connect the ends of proximal tab 15 to the proximal ends of left and right me, dial tabs 17 and 12. In one embodiment, strips 19, 16 have outwardly curved inner and outer margins, with a width less than that of both proximal tab 15 and medial tabs 17, 12. This allows the proximal, lateral surfaces of the nose to be effectively adhered to and sealed. To similar effect, the point of interface of the distal ends of medial tabs 17, 12 with distal tab 13 is defined by inwardly tapered cutout sections 18. Accordingly, as seen on FIG. 1, filter 10 can be bent and curved along its center line and secured to the nose without covering the upper surfaces or protruding.

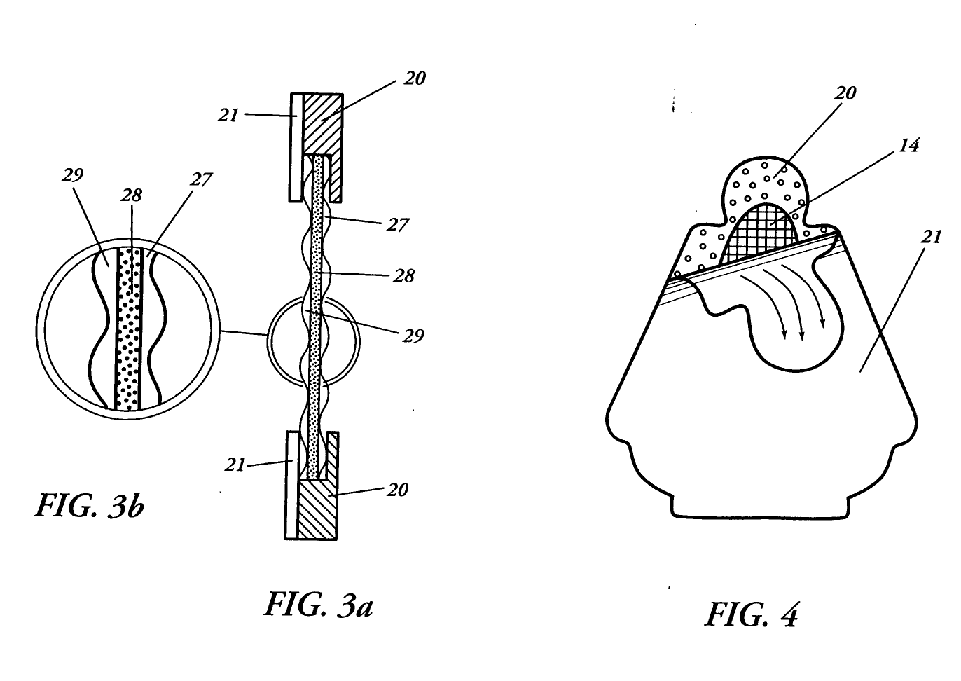

The selection of material for filter section 14 is also critical. A very fine mesh is needed, preferably in the range of 0.1-25 microns (0.0008-0.0010 inches), so that a high percentage of airborne particulate is removed. Moreover, the material must be moisture resistant. Nitex brand nylon woven screening media from Tetko, Inc. is a type of material that can be used in this application. If desired, and as shown on FIGS. 3a and 3b, filter section 14 can include upper and lower fabric layers 27 and 29 surrounding a central fabric layer 28. This will allow the filter to receive a coating or impregnation of activated charcoal, antihistamine, and the like, to enhance the organic filtering and antiallergic properties of the filter.

The skin contacting surface of adhesive section 20 receives a coating of water-resistant, hypoallergenic adhesive, well known to those skilled in the art, which will removably adhere to the skin and to a removable paper backing 21, as shown on FIG. 4.

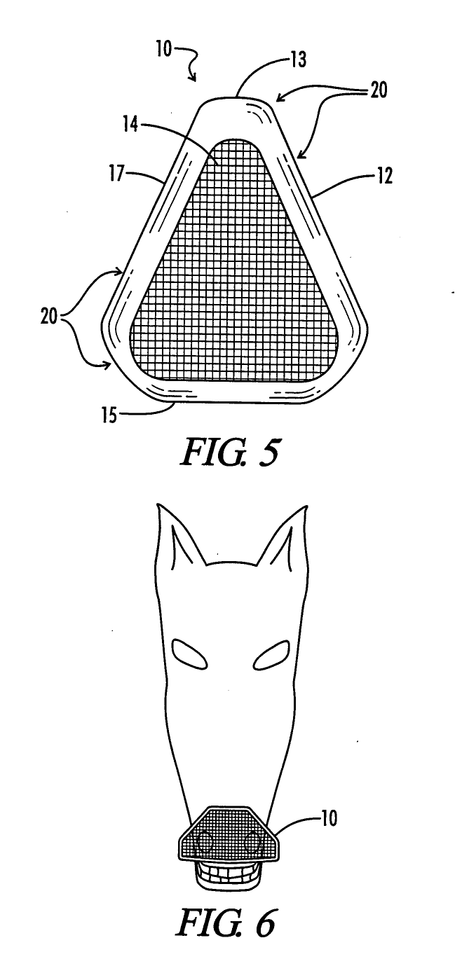

An alternate embodiment of the filter can be seen in FIG. 5. This embodiment shows straight outer and inner margins on the proximal tab used to increase the cross-sectional area of airflow and to increase the volume of air filtration through the filter.

The filter of this invention can also be used on other mammals including but not limited to horses, dogs, cats, and other pets and livestock. FIG. 6 is a representation of the invention applied to animals other than humans. In this embodiment the filtration system does not necessarily have to be a triangular shape but instead can conform to the particular nasal openings for the nasal configuration of the animal that uses the filter.

The filter can include pharmaceutical agents applied on the adhesive section 20 or the filter region 14. The pharmaceutical agents, also called chemical agents, are used to reduce allergic symptoms and can be used to produce a variety of desired physiological effects in the bloodstream of a user of both human and animal users of the filter. For example, the agents can be used to reduce histamines in the bloodstream which line the arterial and frontal sinuses. The agents can be supplied to the user of the filter by a transdermal delivery or a respiratory delivery, depending on the application of the agents to the filter. The agents can also be used to control blood pressure, diabetes, induce sedation, or other desired effects.

The filter system can use a delivery system by which numerous pharmaceutical or chemical agents can be delivered to the human or animal wearer of the filter. The system can introduce the agents by several techniques, including but limited to, transdermal delivery, atomization mists, or gaseous form. The filter region 14 can be composed of metal blown, woven or electrostatic polymers which increase the mechanical filtration of the filter media 14. The filter region 14, when comprised of these polymers or a combination of these polymers, increases the ease of ventilation through the filter and into nasal passages thereby increasing the effectiveness and the filtration quality of the filter for a user of the filter.

Thus, although there have been described particular embodiments of the present invention of a new and useful nose filter, it is not intended that such references be construed as limitations upon the scope of this invention except as set forth in the following claims. Further, although there have been described certain dimensions used in the preferred embodiment, it is not intended that such dimensions be construed as limitations upon the scope of this invention except as set forth in the following claims.

What I claim is:

1. A filter for removing airborne particulate during nasal respiration of a mammal comprising:
a filter section including a substantially triangular shaped synthetic material;
an adhesive section surrounding and attached to the peripheral margin of said filter section, said adhesive section including a distal tab adapted for attachment to the lower surface of the tip of the nose, a proximal tab adapted for attachment to the lower surface of the base of the nose, and left and right medial tabs joining said distal and proximal tabs, said medial tabs adapted for attachment to the lateral surfaces of the nose, said proximal tab including an outer margin and an inner margin and said distal tab including a substantially circular region joined to the distal ends of said medial tabs;
the adhesive section coated on one side with an adhesive whereby said filter can be removably attached to the skin;
a pharmaceutical agent attached to the adhesive section for transdermal introduce of chemicals into the mammal.

2. The filter of claim 1 further including left and right intertabular strips joining the sides of said proximal tab to the proximal ends of said left and right medial tabs, said strips having curved inner and outer margins, and said strips adapted for adhering to and sealing the proximal lateral surfaces of the nose.

3. The filter of claim 1, said adhesive section further including a plurality of pores communicating between the surface of the user's skin and the ambient air.

4. The filter of claim 3, wherein said synthetic mesh fabric comprises nylon having a mesh size substantially in the range of 20 to 25 microns (0.0008-0.0010 inches).

5. The filter of claim 1, further including a removable backing for covering said adhesive prior to use of said filter.

6. The filter of claim 1, wherein the filter section includes meltblown polymers.

7. The filter of claim 1, wherein the filter section includes woven polymers.

8. The filter of claim 1, wherein the filter section includes electrostatic polymers.

9. A filter for removing airborne particulate during nasal respiration of a mammal comprising:
a filter section including a substantially triangular shaped synthetic mesh fabric;
an adhesive section surrounding and attached to the peripheral margin of said filter section, said adhesive section including a distal tab adapted for attachment to the lower surface of the tip of the nose, a proximal tab adapted for attachment to the lower surface of the base of the nose, and left and right medial tabs joining said distal and proximal tabs, said medial tabs adapted for attachment to the lateral surfaces of the nose, said proximal tab including a straight outer margin and inner margins and said distal tab including a substantially circular region joined to the distal ends of said medial tabs;
an adhesive applied to the adhesive section whereby said filter can be removably attached to the skin; and
a pharmaceutical agent mixed with the adhesive for transdermal introduce of chemicals into the mammal.

10. A filter for removing airborne particulate during nasal respiration of a mammal comprising:
a filter section including a substantially triangular shaped synthetic mesh fabric;
an adhesive section surrounding and attached to the peripheral margin of said filter section, said adhesive section including a distal tab adapted for attachment to the lower surface of the tip of the nose, a proximal tab adapted for attachment to the lower surface of the base of the nose, and left and right medial tabs joining said distal and proximal tabs, said medial tabs adapted for attachment to the lateral surfaces of the nose, said proximal tab including a straight outer margin and an arched inner margin and said distal tab including a substantially circular region joined to the distal ends of said medial tabs;
an adhesive applied to the adhesive section whereby said filter can be removably attached to the skin; and
a pharmaceutical agent applied to the filter section for respiratory introduction of chemicals into the mammal.

11. The filter of claim 10, wherein the filter section includes meltblown polymers.

12. The filter of claim 10, wherein the filter section includes woven polymers.

13. The filter of claim 10, wherein the filter section includes electrostatic polymers.

14. A filter for removing airborne particulate during nasal respiration of an animal comprising:
a filter section including a substantially triangular shaped synthetic mesh fabric;
an adhesive section surrounding and attached to the peripheral margin of said filter section, said adhesive section including a distal tab adapted for attachment to the lower surface of the tip of the nose, a proximal tab adapted for attachment to the lower surface of the base of the nose, and left and right medial tabs joining said distal and proximal tabs, said medial tabs adapted for attachment to the lateral surfaces of the nose, said proximal tab including a straight outer margin and an arched inner margin and said distal tab including a substantially circular region joined to the distal ends of said medial tabs;
an adhesive applied to the adhesive section whereby said filter can be removably attached to the nose of the animal.
